(19) United States
(12) Patent Application Publication
(10) Pub. No.: US 2016/0226343 A1
(43) Pub. Date: Aug. 4, 2016

(54) METHOD OF OPERATING A DRIVE DEVICE FOR A MOTOR VEHICLE, AND CORRESPONDING DRIVE DEVICE

(71) Applicant: AUDI AG, lngolstadt (DE)

(72) Inventor: UWE FELDMANN, Nassenfels (DE)

(73) Assignee: AUDI AG, lngolstadt (DE)

(21) Appl. No.: 15/005,617

(22) Filed: Jan. 25, 2016

(30) Foreign Application Priority Data
Jan. 31, 2015 (DE) 10 2015 001 184.7

(51) Int. Cl. H02K 9/14; B60K 1/00

(52) U.S. Cl. CPC H02K 9/14; B60K 1/00; B60K 2001/006

(57) ABSTRACT

In a method of operating a drive device for a motor vehicle, a power electronics that controls an electric machine of the drive device is cooled by a coolant flowing in a first cooling circuit. In order to enhance a cooling effect, the temperature of the coolant in the first cooling circuit is temporarily reduced to a desired level.

### CROSS-REFERENCES TO RELATED APPLICATIONS

This application claims the priority of German Patent Application, Serial No. 10 2015 001 184.7, filed Jan. 31, 2015, pursuant to 35 U.S.C. 119(a)-(d), the disclosure of which is incorporated herein by reference in its entirety as if fully set forth herein.

### BACKGROUND OF THE INVENTION

The present invention relates to a method of operating a drive device for a motor vehicle, and to a corresponding drive device.

The following discussion of related art is provided to assist the reader in understanding the advantages of the invention, and is not to be construed as an admission that this related art is prior art to this invention.

A drive device is typically used to operate a motor vehicle, i.e. to provide a torque for propelling the motor vehicle. The drive device may be part of the motor vehicle and includes at least a drive unit or several drive units, of which at least one is an electric machine and another one may be a drive unit that is different than the electric machine and may be an internal combustion engine for example. In this case, the drive device is constructed as a hybrid drive device.

In the presence of several drive units, these may be used to jointly provide the torque, at least temporarily. When the electrical machine is the only drive unit provided, it generates the torque at least temporarily. The electric machine is activated by a power electronics which may be configured, for example, as inverter, or at least includes an inverter. The inverter is provided to convert a direct current to an alternating current that is typically required to operate the electric machine. In other words, the power electronics is provided to convert electric energy. As such the power electronics includes an electronic component.

The electronic component may, for example, be a transistor, e.g. power transistor or bipolar transistor such as a bipolar transistor with insulated gate electrode. The electronic component may also be a MOSFET, diode, DIAC, TRIAC, thyristor, or the like. Normally, the power electronics includes several or at least one of the afore-mentioned electronic components, for example several transistors or MOSFETs. The power electronics is connected electrically with the electric machine, for example via a coil of the electric machine. The coil may hereby be part of a stator or rotor of the electric machine.

As the power electronics converts electric energy, heat is generated so that cooling of the power electronics is required. For that purpose, a cooling circuit is provided in which a coolant flows, for example through a heat exchanger that is associated to the power electronics. Heat generated by the power electronics is transferred by the heat exchanger to the coolant and dissipated. In the following description, any reference to a feeding of coolant to the power electronics is to be understood as coolant flowing through the heat exchanger as coolant actually does not flow through the power electronics.

It would be desirable and advantageous to provide an improved method of operating a drive device for a motor vehicle to obviate prior art shortcomings and to enable an effective and efficient operation of the motor vehicle.

### SUMMARY OF THE INVENTION

According to one aspect of the present invention, a method of operating a drive device for a motor vehicle includes cooling a power electronics that controls an electric machine of the drive device by a coolant flowing in a first cooling circuit, and temporarily reducing a temperature of the coolant in the first cooling circuit to a level sufficient to enhance a cooling effect.

The present invention resolves prior art problems by temporarily reducing the coolant temperature in the first cooling circuit to improve the cooling effect of the power electronics. Coolant used to cool the power electronics, or fed to the heat exchanger of the power electronics is thus not continuously maintained at a substantially same temperature but cooled down to a lower temperature over a predefined time period. In other words, coolant fed to the power electronics is at a first temperature in a first operating mode and in a second operating mode at a second temperature which is lower than the first temperature. The targeted reduction of the coolant temperature is realized only temporarily and is realized by switching from the first operating mode to the second operating mode. After elapse of the predefined time period, it is switched again from the second operating mode to the first operating mode so that the coolant temperature is adjusted again to the first temperature.

Provision may thus be made for the coolant to have in the first operating mode a first temperature which lies in a first temperature range, and to have in the second operating mode a second temperature which lies in a second temperature range, with the second temperature range at least in part, in particular entirely, being lower than the first temperature range. While the first and second temperature ranges may overlap, it is currently preferred to maintain the second temperature range entirely at a lower level than the first temperature range. The first and second temperature ranges may follow each other immediately, although it is currently preferred to keep them further apart. The first and second temperature ranges may have a same scope, e.g. at least 5K, 10K, 15K, 20K, or 25K.

The temperature of the coolant may be reduced, for example in a situation, when the electric machine should generate a great torque in order to accelerate the motor vehicle, thereby causing the power electronics to produce much heat. In this situation, the coolant temperature is reduced to enhance the cooling effect on the power electronics, advantageously at a same time as acceleration commences. Of course, provision may also be made to initiate a decrease in the coolant temperature at a time instance before the motor vehicle accelerates, e.g. by a predefined time interval before commencement of the acceleration.

According to another advantageous feature of the present invention, the temperature of the coolant in the first cooling circuit can be reduced by feeding a refrigerant to the first cooling circuit at a location upstream of the power electronics and at a temperature which is lower than the temperature of the coolant flowing in the first cooling circuit at said location. The refrigerant can be fed at an appropriate port site. The coolant my have immediately upstream of this port site the first temperature, whereas the temperature of the refrigerant is lower. Advantageously, the temperature of the refrigerant is selected such that the temperature of the coolant is decreased by the refrigerant to the lower second temperature. As a result, the temperature of the refrigerant immediately upstream of the port site is lower than the second temperature.

The refrigerant may be fed only in the second operating mode for example. In the first operating mode, the power electronics is solely cooled by the coolant. The refrigerant may, for example, flow in a second cooling circuit, advantageously in an air conditioning cooling circuit of the motor vehicle. Provision may also be made to jointly feed the coolant and the refrigerant to the power electronics or heat exchanger. In this case, coolant and refrigerant are mixed with one another. Provision may also be made, at least temporarily, to feed the refrigerant to the cooling circuit and to feed it as coolant to the power electronics or heat exchanger. In this case, the refrigerant serves exclusively as coolant.

As an alternative, it is, of course, also possible to feed the refrigerant to the cooling circuit only to such an extent as it is fed through a heat exchanger through which also the coolant of the cooling circuit flows. Also in this case, it is possible for the refrigerant to lower the temperature of the coolant to the level of the second temperature. In this case, coolant and refrigerant are fluidly separated from one another.

According to another advantageous feature of the present invention, the refrigerant can be fed to the first cooling circuit via a mixing valve. The mixing valve thus establishes a flow communication between the first cooling circuit and the second cooling circuit. Advantageously, this flow communication is established only in the second operating mode, while being cut in the first operating mode. The mixing valve may be constructed as a discretely switchable mixing valve that is able to discretely switch between only two flow cross sections, i.e. a fully blocked flow cross section and a fully cleared flow cross section.

As an alternative, the mixing valve may also be constructed as a continuous control valve that is able to adjust a further flow cross section, advantageously several flow cross sections, in addition to the two flow cross sections. As a result, the volume flow of coolant fed to the cooling circuit can be adjusted by such a continuous control valve. Advantageously, the mixing valve in this case can be controlled in dependence on the temperature of the coolant downstream of the mixing valve and/or upstream of the power electronics, and/or the temperature of the power electronics.

According to another advantageous feature of the present invention, the temperature of the coolant in the first cooling circuit can be reduced incrementally or continuously over a predefined time period. In this way, there is no abrupt decrease in the temperature of the coolant so that sudden temperature jumps of the power electronics are avoided. Rather, the temperature reduction is implemented over a predefined time period of a length which is greater than zero. The decrease in temperature may be realized within this time period incrementally, i.e. in discrete increments, or substantially continuously.

According to another advantageous feature of the present invention, the temperature of the coolant in the first cooling circuit can be reduced by feeding a refrigerant to the first cooling circuit from a second cooling circuit and discharging the refrigerant from the first cooling circuit to the second cooling circuit at a location downstream of the power electronics. As described above, a refrigerant can be fed in the first cooling circuit to reduce the temperature of the coolant. The refrigerant is hereby fed upstream of the power electronics or heat exchanger. In other words, the refrigerant flows jointly with the coolant or in the form of coolant through the power electronics or heat exchanger.

The refrigerant is withdrawn from the first cooling circuit downstream of the power electronics or heat exchanger and transferred back to the second cooling circuit. The second cooling circuit can be constructed, as described above, as air conditioning cooling circuit of the motor vehicle. The air conditioning cooling circuit is thus provided not only to keep an interior space of the motor vehicle at a moderate temperature but in addition to improve the cooling effect on the power electronics.

According to another advantageous feature of the present invention, the coolant and the refrigerant can be a same cooling fluid. Advantageously, the cooling fluid can be a freezing agent. Of course the fluid may also be a refrigerant.

According to another advantageous feature of the present invention, the refrigerant can be cooled before being fed to the first cooling circuit by a refrigerating machine. Advantageously, the refrigerant is cooled to a temperature which is lower than the second temperature. The temperature of the refrigerant is hereby selected sufficient to cool the coolant in the first cooling circuit to the second temperature before flowing through the power electronics or heat exchanger. The refrigerating machine may, for example, be part of an air conditioning system of the motor vehicle, in particular an interior air conditioner. Advantageously, the refrigerating machine is a compression refrigerating machine with a corresponding air conditioning compressor.

According to another advantageous feature of the present invention, the temperature of the coolant in the first cooling circuit can be reduced, when a power output of the electric machine is increased, in particular when the power output of the electric machine exceeds a threshold value. As the power output of the electric machine increases, also the heat amount that is generated in the power electronics and has to be dissipated, increases. Thus, when the power output of the electric machine increases or exceeds the threshold value, the temperature of the coolant is reduced. As described above, such a situation can be encountered, when the motor vehicle is accelerated by the drive device. Of course, provision may be made to reduce the temperature before the power output increases, advantageously by a predefined time period. In addition, provision may be made to determine the reduced temperature of the coolant in dependence on the momentary power output of the electric machine.

According to another advantageous feature of the present invention, the reduction in temperature of the coolant can be terminated, when the power output of the electric machine decreases, in particular when the power output of the electric machine drops below a threshold value. A temperature decrease of the coolant is only required when the power electronics generates much heat. Thus, the temperature can be raised again or the temperature reduction can be terminated, when the power output of the electric machine decreases. In other words, a decrease in coolant temperature is implemented only when the power output of the electric machine exceeds the threshold value. Only in this case is a switch to the second operating mode from the first operating mode implemented, whereas the first operating mode is established, when the power output of the electric machine is smaller than or equal to the threshold value.

According to another aspect of the present invention, a drive device for a motor vehicle includes an electric machine, a power electronics configured to operate the electric machine, and a cooling system configured to cool the power electronics, said cooling system having a first cooling circuit and configured to temporarily reduce a temperature of a coolant flowing in the first cooling circuit to a level sufficient to enhance a cooling effect.

The advantages of such a configuration of the drive device have already been described above with reference to the method.

### BRIEF DESCRIPTION OF THE DRAWING

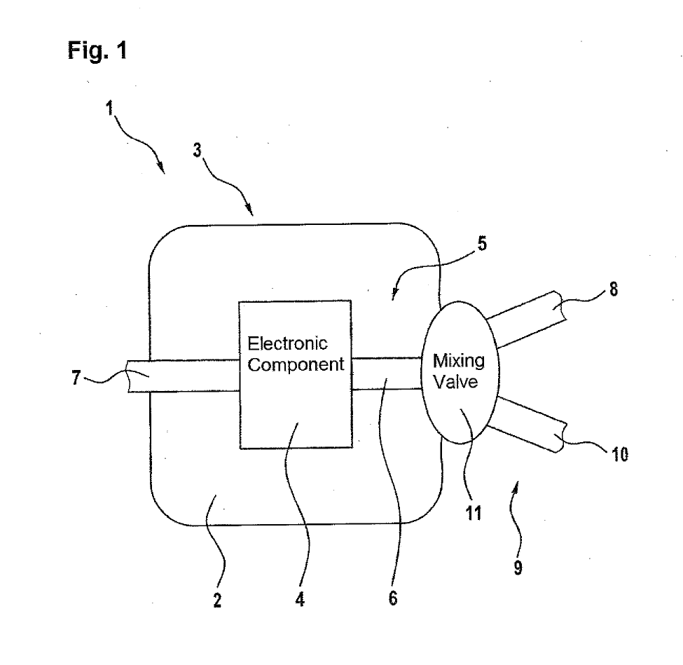

Other features and advantages of the present invention will be more readily apparent upon reading the following description of currently preferred exemplified embodiments of the invention with reference to the accompanying drawing, in which the sole FIG. 1 is a schematic illustration of a portion of a drive device according to the present invention.

### DETAILED DESCRIPTION OF PREFERRED EMBODIMENTS

The depicted embodiment is to be understood as illustrative of the invention and not as limiting in any way. It should also be understood that the figure is may not necessarily be to scale. In certain instances, details which are not necessary for an understanding of the present invention or which render other details difficult to perceive may have been omitted.

Turning now to FIG. 1, there is shown a schematic illustration of a portion of a drive device according to the present invention, generally designated by reference numeral 1, for a motor vehicle. Reference numeral 2 indicates a power electronics 2 which is part of an electric machine, not shown in greater detail, or at least is used to operate the electric machine 3. The power electronics 2 includes an electronic component 4 which can be a bipolar transistor with insulated gate electrode (IGBT) for example.

Associated to the power electronics 2 or at least to the electronic component 4 is a cooling circuit 5 which is part of a cooling system to cool the power electronics 2. The cooling circuit 5 includes a heat exchanger, not shown in greater detail, which is operably connected to the power electronics 2 or electronic component 4 for heat transfer. The heat exchanger is circulated by a coolant flowing in the cooling circuit 5 to cool the power electronics 2. Disposed upstream of the heat exchanger is a lead line 6 and downstream is a return line 7 of the cooling circuit 5. Further part of the cooling circuit 5 is a feed line 8.

In addition to the cooling circuit 5, the cooling system includes a further cooling circuit 9 of which feed line 10 is only shown. The feed lines 8, 10 and the lead line 6 are connected to a mixing valve 11 which is constructed here by way of example to fluidly connect to the lead line 6 only feed line 8, or only feed line 10, or both feed lines 8, 10. For example, coolant can be fed to the lead line 6 solely via the feed line 8. Provision may also be made to feed to the lead line 6 both coolant via feed line 8 and a refrigerant via the feed line 10. Finally, provision may also be made to feed refrigerant only via the feed line 10 to the lead line 6. In this case, the refrigerant acts a coolant that flows through the heat exchanger.

The refrigerant has a temperature that is lower than the temperature of the coolant. Advantageously, the cooling system is configured that a temperature differential between the coolant and the refrigerant upstream of the mixing valve 11 is at least 5 k, at least 10 K, at least 15K, at least 20K, or at least 25 K.

Overall provision is made to tailor a temporary reduction of the temperature of the coolant in the cooling circuit 5 in order to enhance cooling of the power electronics 2. In a first operating mode, solely coolant is fed from the feed line 8 to the power electronics 2. In a second operating mode, refrigerant from the feed line 10 is added to the coolant so as to decrease the coolant temperature. A significant reduction of the coolant temperature can be realized by adjusting the mixing valve 11 in such a way that only refrigerant is fed to the lead line 6 and thereby flow to the power electronics 2 as coolant.

When feeding refrigerant to the cooling circuit 5, it is advantageous when the refrigerant is withdrawn from the cooling circuit 5 again downstream of the power electronics 2 and transferred to the further cooling circuit 9.

The further cooling circuit 9 is, for example, an air conditioning cooling circuit, advantageously an interior air conditioner of the motor vehicle. The temperature reduction of the coolant in the cooling circuit 5 is realized, for example, when the power output of the electric machine 3 increases or exceeds a threshold valve.

A drive device 1 or a method according to the present invention enable operation of the electric machine 3 at significantly greater power output or torque because the increase in heat generated by the power electronics can easily be dissipated.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of operating a drive device for a motor vehicle, comprising:
cooling a power electronics that controls an electric machine of the drive device by a coolant flowing in a first cooling circuit; and
temporarily reducing a temperature of the coolant in the first cooling circuit to a level sufficient to enhance a cooling effect.

2. The method of claim 1, wherein the temperature of the coolant in the first cooling circuit is reduced by feeding a refrigerant to the first cooling circuit at a location upstream of the power electronics and at a temperature which is lower than the temperature of the coolant flowing in the first cooling circuit at said location.

3. The method of claim 2, wherein the refrigerant is fed to the first cooling circuit via a mixing valve.

4. The method of claim 1, wherein the temperature of the coolant in the first cooling circuit is reduced incrementally or continuously over a predefined time period.

5. The method of claim 1, wherein the temperature of the coolant in the first cooling circuit is reduced by feeding a refrigerant to the first cooling circuit from a second cooling circuit and discharging the refrigerant from the first cooling circuit to the second cooling circuit at a location downstream of the power electronics.

6. The method of claim 2, wherein the coolant and the refrigerant are a same cooling fluid.

7. The method of claim 5, wherein the coolant and the refrigerant are a same cooling fluid.

8. The method of claim 2, further comprising cooling the refrigerant by a refrigerating machine before being fed to the first cooling circuit.

9. The method of claim 5, further comprising cooling the refrigerant by a refrigerating machine before being fed to the first cooling circuit.

10. The method of claim 1, wherein the temperature of the coolant in the first cooling circuit is reduced, when a power output of the electric machine is increased.

11. The method of claim 1, wherein the temperature of the coolant in the first cooling circuit is reduced, when a power output of the electric machine exceeds a threshold value.

12. The method of claim 1, further comprising terminating the reduction in temperature of the coolant, when a power output of the electric machine decreases.

13. The method of claim 1, further comprising terminating the reduction in temperature of the coolant, when a power output of the electric machine drops below a threshold value.

14. A drive device for a motor vehicle, comprising:
an electric machine;
a power electronics configured to operate the electric machine; and
a cooling system configured to cool the power electronics, said cooling system having a first cooling circuit and configured to temporarily reduce a temperature of a coolant flowing in the first cooling circuit to a level sufficient to enhance a cooling effect.

15. The drive device of claim 14, further comprising a feeding unit configured to feed a refrigerant to the first cooling circuit at a location upstream of the power electronics and at a temperature which is lower than the temperature of the coolant flowing in the first cooling circuit at said location so as to reduce the temperature of the coolant in the first cooling circuit.

16. The drive device of claim 15, wherein the feeding unit includes a mixing valve.

17. The drive device of claim 15, wherein the feeding unit operates incrementally or continuously over a predefined time period.

18. The drive device of claim 14, wherein the cooling system includes a second cooling circuit in fluid communication with the first cooling circuit to feed a refrigerant to the first cooling circuit, said refrigerant being discharged from the first cooling circuit to the second cooling circuit at a location downstream of the power electronics.

19. The drive device of claim 15, wherein the coolant and the refrigerant are a same fluid.
